(19) United States
(12) Patent Application Publication
(10) Pub. No.: US 2024/0188044 A1
(43) Pub. Date: Jun. 6, 2024

(54) METHODS FOR COMMUNICATION, TERMINAL DEVICES, AND COMPUTER READABLE MEDIA

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/285,078

(22) PCT Filed: Apr. 2, 2021
(86) PCT No.: PCT/CN2021/085382

§ 371 Date: Sep. 29, 2023

(51) Int. Cl. H04W 72/02; H04W 72/0446; H04W 72/40; H04W 76/28

(52) U.S. Cl. CPC H04W 72/02; H04W 72/0446; H04W 72/40; H04W 76/28

(57) ABSTRACT

Embodiments of the present disclosure provide a solution for sidelink transmission. In a method for communication, a first terminal device determines a resource selection window for a sidelink transmission from the first terminal device to a second terminal device. Then, the first terminal device determines a duration within the resource selection window. Further, the first terminal device determines at least one resource for the sidelink transmission within the resource selection window without the duration. In this way, the resource selection window of the first terminal device for the sidelink transmission is optimized, thereby improving the performance of the sidelink transmission.

### FIELD

Embodiments of the present disclosure generally relate to the field of communication, and more particularly, to a solution for sidelink transmissions.

### BACKGROUND

5G New Radio (NR) is the global standard for a unified and more capable 5G wireless air interface. 5G enables a new kind of network that is designed to connect virtually everyone and everything together including machines, objects, and devices. The 5G NR is part of a continuous mobile broadband evolution promulgated by the Third Generation Partnership Project (3GPP) to meet new requirements associated with latency, reliability, security, scalability (for example, with Internet of Things), and other requirements. Some aspects of the 5G NR may be based on the 4G Long Term Evolution (LTE) standards.

In LTE vehicle-to-everything (V2X), when UE performs partial sensing, UE shall determine, by its implementation, a set of subframes which consists of at least Y subframes within a resource selection window. Y shall be greater than or equal to the high layer parameter minNumCandidateSF. If a subframe t_y is included in the set of Y subframes in above step, the UE shall monitor any subframe t_y-k*p if k-th bit of the high layer parameter gapCandidateSensing is set to 1. The UE shall perform the behavior of resource exclusion based on Physical Sidelink Control Channel (PSCCH) decoded and Sidelink Received Signal Strength Indicator (S-RSSI) measured in these subframes, namely, the sensing procedure defined in the related 3GPP specifications. However, the resource selection window in the partial sensing procedure of the UE may need to be optimized in some sidelink communication scenarios.

### SUMMARY

In general, embodiments of the present disclosure provide a solution for sidelink transmissions.

In a first aspect, there is provided a method for communication. The method comprises determining, at a first terminal device, a resource selection window for a sidelink transmission from the first terminal device to a second terminal device. The method also comprises determining a duration within the resource selection window. The method further comprises determining, within the resource selection window without the duration, at least one resource for the sidelink transmission.

In a second aspect, there is provided a method for communication. The method comprises receiving, at a second terminal device from a first terminal device, cast type information of a sidelink transmission from the first terminal device to the second terminal device. The method also comprises determining, based on the cast type information, an enablement configuration of a sidelink discontinuous reception (DRX) of the second terminal device during the sidelink transmission.

In a third aspect, there is provided a first terminal device. The first terminal device comprises a processor configured to perform the method according to the first aspect.

In a fourth aspect, there is provided a second terminal device. The second terminal device comprises a processor configured to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates a schematic diagram of an example communication environment in which some embodiments of the present disclosure can be implemented;

FIG. 1B illustrates a schematic diagram of another example communication environment in which some embodiments of the present disclosure can be implemented;

FIG. 2 illustrates an example process of a method for communication in accordance with some embodiments of the present disclosure;

FIG. 3 illustrates a schematic diagram showing a resource selection window for a sidelink transmission from a transmitting terminal device without an off-duration of a receiving terminal device of the sidelink transmission in accordance with some embodiments of the present disclosure;

FIG. 4A illustrates a schematic diagram showing a common off-duration and a combined off-duration of multiple receiving terminal devices of a groupcast or broadcast sidelink transmission in accordance with some embodiments of the present disclosure;

FIG. 4B illustrates a schematic diagram showing a common on-duration and a combined on-duration of multiple receiving terminal devices of a groupcast or broadcast sidelink transmission in accordance with some embodiments of the present disclosure;

FIG. 5 illustrates a schematic diagram showing that a partial resource selection window is extended to include more slots in accordance with some embodiments of the present disclosure;

FIG. 6 illustrates an example process for selecting one or more resources for a sidelink transmission from a transmitting terminal device to a receiving terminal device in accordance with some embodiments of the present disclosure;

FIGS. 7A and 7B illustrate schematic diagrams showing that if a resource is selected for a sidelink transmission, there may be no available resource for a retransmission of the sidelink transmission in accordance with some embodiments of the present disclosure;

FIG. 8 illustrates a schematic diagram showing that a transmitting terminal device of a sidelink transmission can select candidate resources in slots associated with sensing occasions located in an on-duration of the transmitting terminal device in accordance with some embodiments of the present disclosure;

FIG. 9 illustrates an example communication process between a first terminal device and a second terminal device in accordance with some embodiments of the present disclosure;

FIG. 10 illustrates an example process of another method for communication in accordance with some embodiments of the present disclosure; and

FIG. 11 illustrates a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communications. Examples of a network device include, but not limited to, a Node B (NodeB or NB), an Evolved NodeB (eNodeB or eNB), a next generation NodeB (gNB), an infrastructure device for a V2X (vehicle-to-everything) communication, a Transmission/Reception Point (TRP), a Remote Radio Unit (RRU), a radio head (RH), a remote radio head (RRH), a low power node, such as a femto node, a pico node, and the like.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, devices on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UEs as examples of terminal devices and the terms “terminal device” and “user equipment” (UE) may be used interchangeably in the context of the present disclosure.

In some embodiments, a terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is an eNB and the second RAT device is a gNB. Information related to different RATs may be transmitted to the terminal device from at least one of the first network device and the second network device. In some embodiments, first information may be transmitted to the terminal device from the first network device and second information may be transmitted to the terminal device from the second network device directly or via the first network device. In some embodiments, information related to configuration for the terminal device configured by the second network device may be transmitted from the second network device via the first network device. Information related to reconfiguration for the terminal device configured by the second network device may be transmitted to the terminal device from the second network device directly or via the first network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (memories) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “transmission reception point,” “transmission/reception point,” or “transmission and reception point” may generally indicate a station communicating with the user equipment. However, the transmission and reception point may be referred to as different terms such as a base station (BS), a cell, a Node-B, an evolved Node-B (eNB), a next generation NodeB (gNB), a Transmission Reception Point (TRP), a sector, a site, a base transceiver system (BTS), an access point (AP), a relay node (RN), a remote radio head (RRH), a radio unit (RU), an antenna, and the like.

That is, in the context of the present disclosure, the transmission and reception point, the base station (BS), or the cell may be construed as an inclusive concept indicating a portion of an area or a function covered by a base station controller (BSC) in code division multiple access (CDMA), a Node-B in WCDMA, an eNB or a sector (a site) in LTE, a gNB or a TRP in NR, and the like. Accordingly, a concept of the transmission and reception point, the base station (BS), and/or the cell may include a variety of coverage areas such as a mega-cell, a macro-cell, a micro-cell, a pico-cell, a femto-cell, and the like. Furthermore, such concept may include a communication range of the relay node (RN), the remote radio head (RRH), or the radio unit (RU).

In the context of the present disclosure, the user equipment and the transmission/reception point may be two transmission/reception subjects, having an inclusive meaning, which are used to embody the technology and the technical concept disclosed herein, and may not be limited to a specific term or word. Furthermore, the user equipment and the transmission/reception point may be uplink or downlink transmission/reception subjects, having an inclusive meaning, which are used to embody the technology and the technical concept disclosed in connection with the present disclosure, and may not be limited to a specific term or word. As used herein, an uplink (UL) transmission/reception is a scheme in which data is transmitted from user equipment to a base station. Alternatively, a downlink (DL) transmission/reception is a scheme in which data is transmitted from the base station to the user equipment.

As used herein, the singular forms “a,” “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, the resource selection window in the partial sensing procedure of a UE may need to be optimized in some sidelink communication scenarios. In order to solve such a technical problem and potentially other technical problems in the conventional solutions, embodiments of the present disclosure provide a solution for sidelink transmissions. In a method for communication, a first terminal device determines a resource selection window for a sidelink transmission from the first terminal device to a second terminal device. Then, the first terminal device determines a duration within the resource selection window. Further, the first terminal device determines at least one resource for the sidelink transmission within the resource selection window without the duration. In this way, the resource selection window of the first terminal device for the sidelink transmission is optimized, thereby improving the performance of the sidelink transmission. Principles and implementations of the present disclosure will be described in detail below.

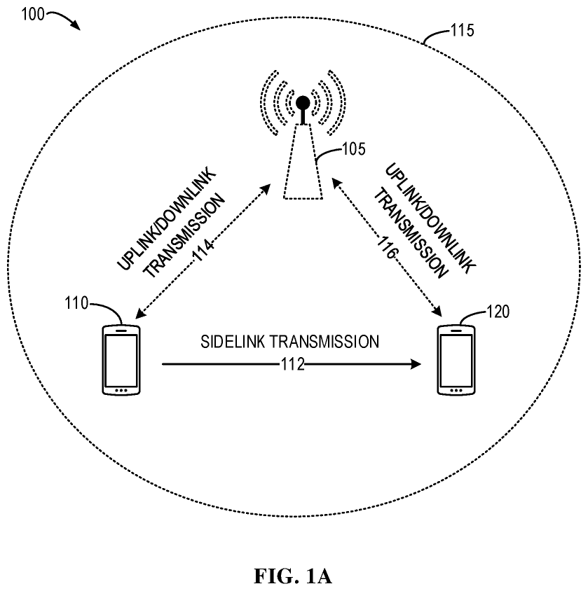

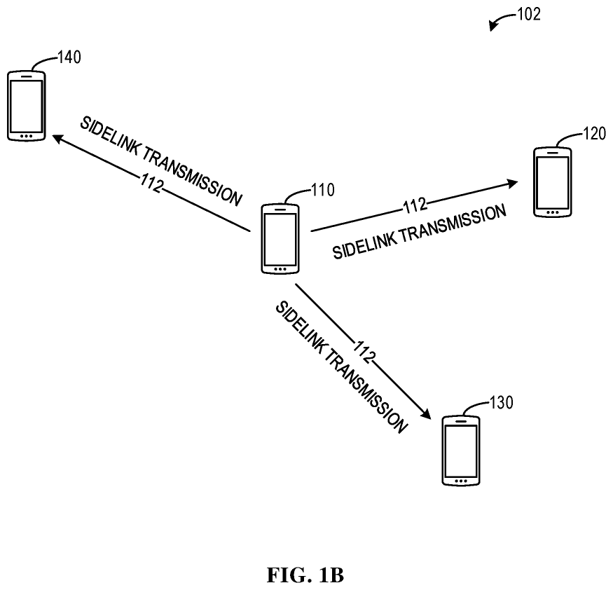

FIG. 1A illustrates a schematic diagram of an example communication environment 100 in which some embodiments of the present disclosure can be implemented. As shown in FIG. 1A, the communication environment 100, which may also be referred to as a communication network 100, can include a network device 105 serving a first terminal device 110 and a second terminal device 120. In particular, uplink transmissions and downlink transmissions can be performed between the first terminal device 110 and the network device 105 via a communication link 114, and uplink transmissions and downlink transmissions can also be performed between the second terminal device 120 and the network device 105 via a communication link 116.

Additionally, the first terminal device 110 may communicate with the second terminal device 120 via a device-to-device (D2D) link, which may also be referred to as a sidelink as used herein. In some situations, the network device 105 can control or assist the sidelink communications between the first terminal device 110 and the second terminal device 120. In some cases, however, the network device 105 may be absent in the communication environment 100. For example, one or more of the first terminal device 110, the second terminal device 120 and other terminal devices (not shown) may be out of the coverage 115 of the network device 105. In such cases, only sidelink communications exist between the first terminal device 110 and the second terminal device 120 as well as possibly other terminal devices not shown in FIG. 1A.

In some embodiments, during sidelink communications between the first terminal device 110 and the second terminal device 120, the first terminal device 110 can perform a sidelink transmission 112 to the second terminal device 120 using a set of transmission resources. In the example scenario of FIG. 1A, since the sidelink transmission 112 is only transmitted to the second terminal device 120, the sidelink transmission 112 can be a unicast sidelink transmission. As used herein, the term “sidelink transmission” generally refers to any transmission performed from one terminal device to another terminal device via a sidelink channel between them. The sidelink transmission may be used for transmitting any data or control information associated with sidelink communications, for example, sidelink data or sidelink control information or sidelink feedback information. As used herein, the term “sidelink channel” may generally refer to any channels for sidelink communications, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

In some embodiments, the first terminal device 110 and the second terminal device 120 may communicate with each other based on a time unit, e.g. time slots (or slots for short). For example, for subcarrier spacing configuration p, slots are numbered nₛ^{μ}∈{0, . . . , Nₛₗₒₜ^{subframe,μ}−1} in an increasing order within a subframe and n_{s,f}^{μ}∈{0, . . . , Nₛₗₒₜ^{frame,μ}−1} in an increasing order within a frame. There are N_{symb}^{slot} consecutive Orthogonal Frequency Division Multiplexing (OFDM) symbols in a slot where N_{symb}^{slot} depends on the cyclic prefix as given in related 3GPP specifications (TS 38.211). The start of slot nₛ^{μ} in a subframe is aligned in time with the start of OFDM symbol nₛ^{μ}N_{symb}^{slot} in the same subframe. Other related definitions and information of slots can be found in existing or future 3GPP specifications. More generally, the term slot as used herein can refer to any existing defined unit of time or any unit of time to be defined in the future.

FIG. 1B illustrates a schematic diagram of another example communication environment 102 in which some embodiments of the present disclosure can be implemented. Different from the example scenario of FIG. 1A, the first terminal device 110 in FIG. 1B may simultaneously transmit the sidelink transmission 112 to multiple terminal devices including the second terminal device 120, a third terminal device 130 and a fourth terminal device 140. For example, the sidelink transmission 112 in the example scenario of FIG. 1B may be a groupcast or broadcast sidelink transmission. Although not shown in FIG. 1B, the first, second, third, and fourth terminal devices 110, 120, 130 and 140 may be served by one or more network devices, and these network devices may control or assist sidelink transmissions among the terminal devices 110, 120, 130 and 140. In some cases, however, the network devices may be absent in the communication environment 102. In such cases, only sidelink communications exist among the terminal devices 110, 120, 130 and 140 as well as possibly other terminal devices not shown in FIG. 1B.

As used herein, the term “resource,” “transmission resource,” or “sidelink resource” may refer to any resource for performing a communication, for example, a sidelink communication between terminal devices, such as a resource in time domain (for example, a time slot), a resource in frequency domain (for example, a sub-channel), a resource in space domain, a resource in code domain, or any other resource enabling a communication, and the like. In the following, a resource in both frequency domain and time domain may be used as an example of a sidelink resource for describing some embodiments of the present disclosure. However, it is noted that embodiments of the present disclosure are equally applicable to any other resources in any other domains.

Although the network device 105, the first terminal device 110, the second terminal device 120, the third terminal device 130 and the fourth terminal device 140 are described in the communication environment 100 and 102 of FIGS. 1A and 1B, embodiments of the present disclosure may be equally applicable to any other suitable communication devices in communication with one another. That is, embodiments of the present disclosure are not limited to the example scenarios of FIGS. 1A and 1B. In this regard, it is noted that although the first terminal device 110, the second terminal device 120, the third terminal device 130 and the fourth terminal device 140 are schematically depicted as mobile phones in FIGS. 1A and 1B, it is understood that this depiction is only for example without suggesting any limitation. In other embodiments, the first terminal device 110, the second terminal device 120, the third terminal device 130 and the fourth terminal device 140 may be any other wireless communication devices, for example, vehicle-mounted terminal devices.

In case the first terminal device 110, the second terminal device 120, the third terminal device 130 and the fourth terminal device 140 are vehicle-mounted terminal devices, the communications relate to them may be referred to as V2X communications. More generally, although not shown in FIGS. 1A and 1B, a V2X communication related to the first terminal device 110, the second terminal device 120, the third terminal device 130 and the fourth terminal device 140 may comprise a communication among the first terminal device 110, the second terminal device 120, the third terminal device 130 and the fourth terminal device 140 and any other communication device, including but not limited to, an infrastructure device, another vehicle-mounted terminal device, a device of a pedestrian, a roadside unit, or the like. Furthermore, although not shown, all the communication links as shown in FIGS. 1A and 1B may be via one or more relays.

It is to be understood that the number of the terminal devices and the number of the network devices as shown in FIGS. 1A and 1B are only for the purpose of illustration without suggesting any limitations. The communication environments 100 and 102 may include any suitable number of terminal devices, any suitable number of network devices, and any suitable number of other communication devices adapted for implementing embodiments of the present disclosure. In addition, it would be appreciated that there may be various wireless communications as well as wireline communications (if needed) among all the communication devices.

The communications in the communication environments 100 and 102 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

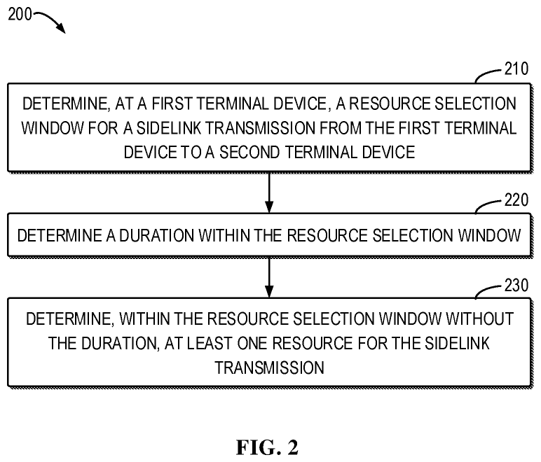

FIG. 2 illustrates an example process 200 of a method for communication in accordance with some embodiments of the present disclosure. In some embodiments, the example process 200 can be implemented at a terminal device, such as the first terminal device 110 as shown in FIG. 1A or 1B. Additionally or alternatively, the example process 200 can also be implemented at other terminal devices not shown in FIGS. 1A and 1B. For the purpose of discussion, the example process 200 will be described as being performed by the first terminal device 110 without loss of generality with reference to FIGS. 1A, 1B as well as FIG. 3. FIG. 3 illustrates a schematic diagram showing a resource selection window for a sidelink transmission from a transmitting terminal device without an off-duration of a receiving terminal device of the sidelink transmission in accordance with some embodiments of the present disclosure.

Referring both FIGS. 2 and 3, at block 210 of FIG. 2, the first terminal device 110 may determine a resource selection window 305 for the sidelink transmission 112 from the first terminal device 110 to the second terminal device 120. As used herein, the resource selection window 305 initially or originally determined by the first terminal device 110 can also be referred to as a first resource selection window. More generally, in a resource pool pre-configured or configured with at least partial sensing, if a UE performs periodic-based partial sensing, at least when the reservation for another Transport Block, TB (when carried in sidelink control information, SCI) is enabled for the resource pool and resource selection or reselection is triggered at slot n, it is up to UE implementation to determine a set of Y candidate slots within a resource selection window. In some embodiments, the resource selection window 305 can be determined based on the slot n in which the first terminal device 110 determines to transmit the sidelink transmission 112. For example, in the slot n, a higher layer of the first terminal device 110 may request a subset of candidate resources for the sidelink transmission 112, namely, trigger the resource selection for the sidelink transmission 112. In this event, the resource selection window 305 can be determined as [n+T1, n+T2], where the selections of T1 and T2 can be up to UE implementation. In some embodiments, there may be a predefined maximum value and/or a predefined minimum value of each of T1 and T2.

At block 220, the first terminal device 110 may determine one or more duration(s) within the resource selection window 305. In general, the one or more durations determined by the first terminal device 110 may be any duration in which the first terminal device 110 may need to avoid the resource selection and the sidelink transmission 112. For example, based on information related to the second terminal device 120, the first terminal device 110 may determine that the second terminal device 120 cannot receive the sidelink transmission 112 during the determined one or more durations. In this event, the first terminal device may need to determine resources for the sidelink transmission 112 within the resource selection window 305 without the one or more determined durations, so as to ensure that the sidelink transmission 112 can be received by the second terminal device 120. In other words, the first terminal device 110 can determine a partial resource selection window, which is the remaining part of the resource selection window 305 after excluding the determined one or more durations. As used herein, the partial resource selection window without the determined one or more durations may also be referred to as a second resource selection window. In the following, some embodiments will be described under the assumption that one duration is excluded from the resource selection window 305. However, it should be appreciated that embodiments of the present disclosure can be equally applicable to the scenarios in which two or more durations are excluded from resource selection window 305.

At block 230, the first terminal device 110 may determine one or more resources within the resource selection window 305 without the duration, namely, the partial resource selection window. The determined one or more resources are to be used by the first terminal device 110 for transmitting the sidelink transmission 112. In this way, since the partial resource selection window does not include the duration in which the sidelink transmission 112 may need to be prevented, the resource selection window of the first terminal device 110 for the sidelink transmission 112 is optimized, thereby improving the performance of the sidelink transmission 112.

In some embodiments, it is assumed that the second terminal device 120 enables a sidelink DRX mechanism and may inform the first terminal device 110 about the sidelink DRX configuration of the second terminal device 120. For example, before the first terminal device 110 performs the partial sensing procedure for the sidelink transmission 112, the second terminal device 120 may transmit information of the sidelink DRX configuration to the first terminal device 110. According to the sidelink DRX configuration, there are on-durations (for example, the on-duration 340) and off-durations (for example, the off-duration 320) for the sidelink receiving operations of the second terminal device 120. In the on-durations of the sidelink DRX mechanism, the second terminal device 120 may be active and thus can receive sidelink transmissions, whereas in the off-durations of the sidelink DRX mechanism, the second terminal device 120 may be inactive and thus cannot receive sidelink transmissions. As used herein, an off-duration can also be termed as an inactive time or inactive duration.

In the case that the second terminal device 120 enables the sidelink DRX mechanism, the partial resource selection window 310 may be the set of slots located within the original resource selection window 305 excluding off-durations (for example, the off-duration 320) of the DRX pattern of the second terminal device 120, for example, including a part 310-1 and a part 310-2. In some embodiments, for determining the one or more resources for the sidelink transmission 112, the first terminal device 110 may select candidate resources (such as resources in slots 312 and 314) from the partial resource selection window 310. More generally, a transmitting UE may determine Y slots within a partial resource selection window. Then, the first terminal device 110 can perform sensing measurements in sensing occasions (such as slots 322 and 324) associated with the slots 312 and 314, respectively. There is an interval 302 between the slot 312 or 314 and the sensing occasion 322 or 324. In some embodiments, the interval 302 can be determined according to some parameters (such as, the parameters k and p) defined in related 3GPP specifications, such as, TS 36.213.

Accordingly, in some embodiments, when determining the duration to be excluded from the partial resource selection window 310, the first terminal device 110 may determine the duration based on a DRX configuration of the second terminal device 120. In this way, the first terminal device 110 can determine the partial resource selection window 310 in view of the DRX configuration of the second terminal device 120, so that the partial sensing procedure of the first terminal device 110 can be applied together with the DRX mechanism of the second terminal device 120. As such, power consumption of both the first terminal device 110 and the second terminal device 120 can be effectively reduced. On the other hand, the first terminal device 110 can ensure that the sidelink transmission 112 to the second terminal device 120 is receivable under DRX impact. In contrast, conventional solutions of partial sensing do not consider DRX impact, and thus a receiving UE cannot receive sidelink transmission during DRX off-duration. Some embodiments of the present disclosure define new UE behaviors of resource selection when configured with both DRX and partial sensing.

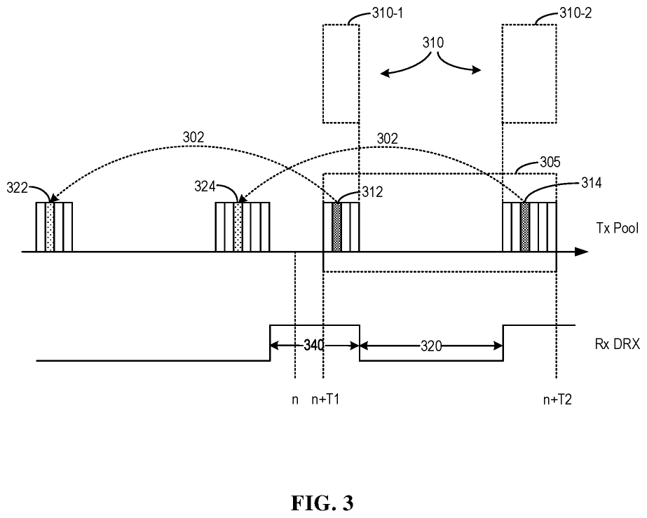

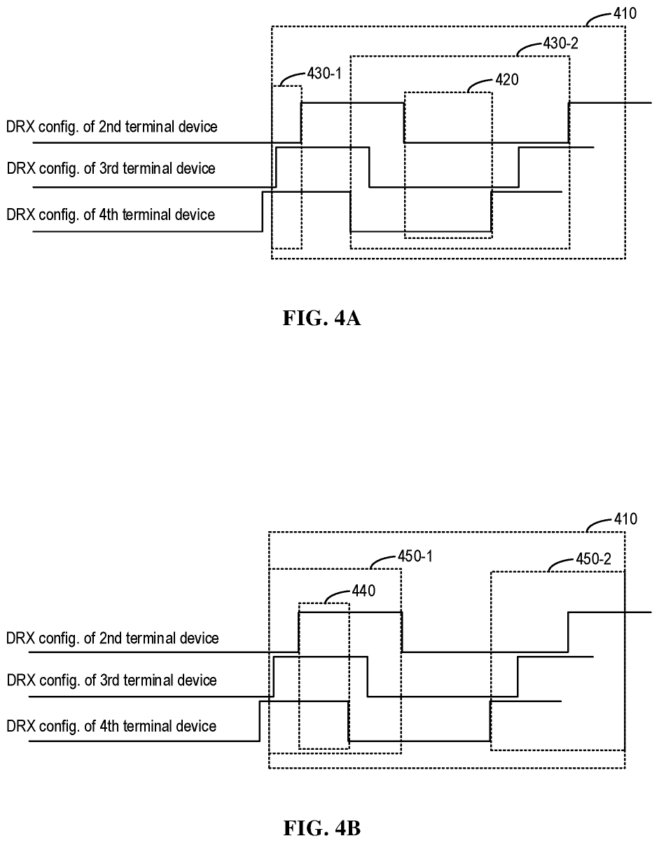

In some embodiments, when determining the duration based on the sidelink DRX configuration of the second terminal device 120, if the sidelink transmission 112 is a unicast sidelink transmission to the second terminal device 120, the first terminal device 110 may determine an off-duration (for example, the off-duration 302) of the DRX configuration of the second terminal device 120 as the duration to be excluded from the partial resource selection window 310. In this way, the first terminal device 110 can ensure that the sidelink transmission 112 can be received by the second terminal device 120, thereby improving the reliability of the sidelink transmission. In some other scenarios, the sidelink transmission 112 can be a groupcast or broadcast sidelink transmission to multiple terminal devices, such as shown in FIG. 1B. In these scenarios, respective off-durations of the multiple terminal devices may need to be considered when determining the duration to be excluded from the partial resource selection window 310. Such embodiments will now be described with reference to FIGS. 4A and 4B.

FIG. 4A illustrates a schematic diagram showing a common off-duration and a combined off-duration of multiple receiving terminal devices of a groupcast or broadcast sidelink transmission in accordance with some embodiments of the present disclosure. As shown in FIG. 4A, the second terminal device 120, the third terminal device 130 and the fourth terminal device 140 may have respective and different DRX configurations. For example, the second, third and fourth terminal devices 120, 130 and 140 may have respective misaligned off-durations. However, as can be seen from FIG. 4A, there is a common off-duration (namely a common portion) 420 and combined off-durations (namely the union of the off-durations) 430-1 and 430-2 of the DRX configurations of the second, third and fourth terminal devices 120, 130 and 140.

In the example scenario shown in FIG. 4A, when determining the duration based on the sidelink DRX configuration of the second terminal device 120, the first terminal device 110 can actually determine the duration based on a common off-duration or a combined off-duration of the multiple receiving terminal devices. More specifically, if the sidelink transmission 112 is a groupcast or broadcast sidelink transmission to multiple terminal devices including the second terminal device 120, then the first terminal device 110 may determine multiple off-durations of respective sidelink DRX configurations of the multiple terminal devices 120, 130 and 140. The first terminal device 110 may then determine the common off-duration 420 of the multiple off-durations as the duration to be excluded from the partial resource selection window 310. For instance, the common off-duration 420 can be a common off-duration of member UEs in a groupcast sidelink transmission. In this way, the duration to be excluded from the partial resource selection window 310 can be shortened, so that there can be more candidate resources in the partial resource selection window 310 for the groupcast or broadcast sidelink transmission. Alternatively, the first terminal device 110 may determine a combined off-duration of the multiple off-durations as the duration to be excluded from the partial resource selection window 310. For instance, the combined off-duration 430-1 or 430-2 may be a union off-duration of member UEs in a groupcast sidelink transmission. In this way, the first terminal device 110 can ensure that all the target terminal devices of the groupcast or broadcast sidelink transmission can receive the groupcast or broadcast sidelink transmission, thereby improving the reliability of the groupcast or broadcast sidelink transmission.

FIG. 4B illustrates a schematic diagram showing a common on-duration and a combined on-duration of multiple receiving terminal devices of a groupcast or broadcast sidelink transmission in accordance with some embodiments of the present disclosure. As shown in FIG. 4B, there is a common on-duration 440 and combined on-durations 450-1 and 450-2 of the DRX configurations of the second, third and fourth terminal devices 120, 130 and 140. From a perspective of a common on-duration or a combined on-duration, the first terminal device 110 can include the common on-duration 440 into the partial resource selection window 310, so as to ensure that all the target terminal devices of the groupcast or broadcast sidelink transmission can receive the groupcast or broadcast sidelink transmission. In contrast, the first terminal device 110 can include the combined on-durations 450-1 and 450-2 into the partial resource selection window 310, so that there can be more candidate resources in the partial resource selection window for the groupcast or broadcast sidelink transmission.

In some embodiments, the first terminal device 110 may perform sidelink transmissions in a half-duplex mode, which means that the first terminal device 110 cannot transmit a sidelink transmission and receive another sidelink transmission, simultaneously. Therefore, if the first terminal device 110 performs a sidelink transmission in a slot, the first terminal device 110 may be unable to monitor the same slot as a sensing occasion. As a result, the first terminal device 110 cannot determine whether there will be another sidelink transmission in a future slot associated with the sensing occasion. In this event, the first terminal device 110 can also exclude such a future slot from the partial resource selection window 310, so as to ensure that the available resources determined from the partial resource selection window 310 after sensing measurements are not reserved by other terminal devices. More particularly, if a previous sidelink transmission from the first terminal device 110 is performed in a sensing occasion associated with a slot within the partial resource selection window 310, the first terminal device 110 may exclude the slot from the partial resource selection window 310. In other words, the partial resource selection window 310 can further exclude a slot set H. H stands for the slots (m) whose associated sensing occasions (m-k*p) are slots where the transmitting UE's sidelink transmission occurred, where k is configured or predefined by RRC, for example, 1, 2 . . . , and p is configured or predefined as at least one of the supported reservation periods by the resource pool and converted to number of slots. In this way, the first terminal device 110 can ensure that the available resources determined from the partial resource selection window 310 after sensing measurements are not reserved by other terminal devices, thereby improving the reliability of the sidelink transmission.

Since the partial resource selection window 310 is shorter than the original resource selection window 305, there may be resource shortage issues and resource selection collision issues after excluding the aforementioned duration, such as an off-duration of the second terminal device 120. Therefore, in some embodiments, if the number of slots within the partial resource selection window 310 without the duration is less than a threshold, the first terminal device 110 may perform a resource selection enhancement, for example, extending the partial resource selection window 310. In this way, there may be more candidate resources in the extended partial resource selection window that can be selected by the first terminal device 110. In some embodiments, the threshold may be a value pre-configured or configured by a higher layer of the first terminal device 110. In some other embodiments, the threshold can be an integer and can be informed to the first terminal device 110 via an RRC message. In this way, whether the number of slots within the partial resource selection window 310 is insufficient can be reasonably controlled by the higher layer, for example, based on the traffic conditions or the like, thereby increasing the reasonability of the threshold.

In some other embodiments, the threshold may be a minimum number of slots within the resource selection window 305 pre-configured or configured by the higher layer. In other words, the threshold may be the minimum value of Y which is pre-configured or configured by the higher layer. In this way, the threshold can be configured to be consistent with the minimum number of slots within the resource selection window 305, which is an existing parameter, so that the higher layer does not need to configure the threshold in addition to the minimum number of slots, thereby simplifying the operations of the higher layer. In some further embodiments, the threshold may be a sum of the minimum number and the number of slots for a round trip time (RTT) of a retransmission of the sidelink transmission 112. In other words, the threshold may be the minimum value of Y plus a gap of slots needed for an RTT of at least one HARQ retransmission, where the RTT time is determined by the following: a time gap between the end of the last symbol of a Physical Sidelink Shared Channel (PSSCH) transmission of the first resource and the start of the first symbol of the corresponding Physical Sidelink Feedback Channel (PSFCH) reception determined by sl-MinTimeGapPSFCH and sl-PSFCH-Period for the pool of resources; and a time required for PSFCH reception and processing plus sidelink retransmission preparation including multiplexing of necessary physical channels and any TX-RX or RX-TX switching time. In this way, the first terminal device 110 can ensure that there are available resources for a retransmission of the sidelink transmission 112, thereby improving the reliability of the sidelink transmission 112.

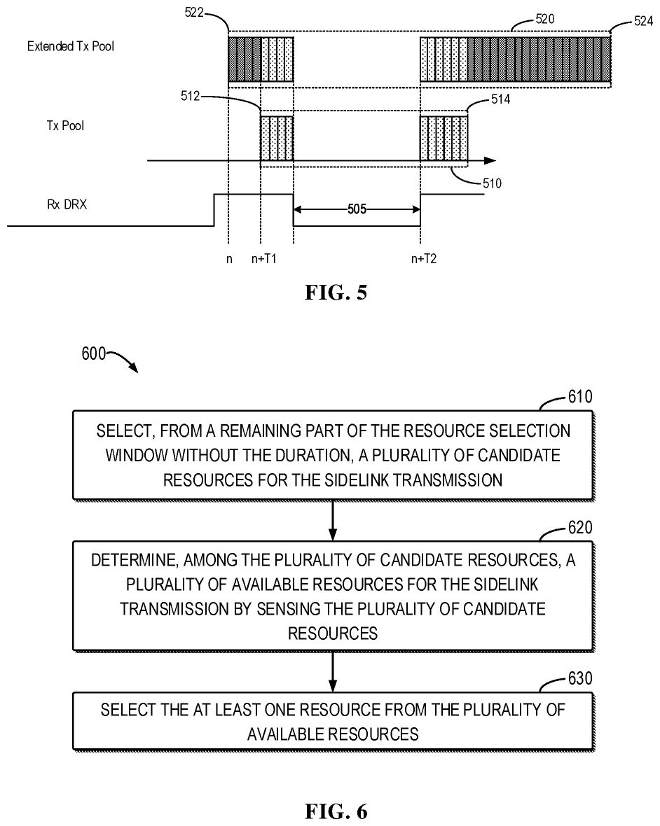

FIG. 5 illustrates a schematic diagram showing that a partial resource selection window is extended to include more slots in accordance with some embodiments of the present disclosure. In the example scenario of FIG. 5, it is assumed that the first terminal device 110 determines a partial resource selection window 510 excluding an off-duration 505 of the second terminal device 120. In some embodiments, for extending the partial resource selection window 510, the first terminal device 110 may advance a start time point 512 of the partial resource selection window 510. For example, the extended partial resource selection window 520 may have a new start time point 522. In this way, the first terminal device 110 can extend the partial resource selection window 510 in the backward direction in the time domain, so that there may be more candidate resources that can be selected from the extended partial resource selection window 520, thereby improving the reliability of the sidelink transmission 112.

Alternatively or additionally, the first terminal device 110 may delay an end time point 514 of the partial resource selection window 510. For example, the extended partial resource selection window 520 may have a new end time point 524. In this way, the first terminal device 110 can extend the partial resource selection window 510 in the forward direction in the time domain, so that there may be more candidate resources that can be selected from the extended partial resource selection window 520, thereby improving the reliability of the sidelink transmission 112. In some embodiments, the first terminal device 110 can set the extended partial resource selection window 520 to be [n+T1, n+T2] in which T1=0 and T2=packet delay budget (PDB) or remaining packet delay budget, such that [n+T1, n+T2] contains more slots.

In some other embodiments, for extending the partial resource selection window 510, the first terminal device 110 may determine an adjusted sidelink DRX configuration of the second terminal device 120 such that the duration (for example, the off-duration 505 of the second terminal device 120) to be excluded from the partial resource selection window 510 is shortened or eliminated. In some embodiments, the adjusted sidelink DRX configuration may be a totally reconfigured sidelink DRX configuration different from the previous sidelink DRX configuration. In some other embodiments, the adjusted sidelink DRX configuration can be a modified version of the previous sidelink DRX configuration. Then, the first terminal device 110 may transmit an indication of the adjusted sidelink DRX configuration to the second terminal device 120. Upon receiving the indication of the adjusted sidelink DRX configuration, the second terminal device 120 can apply the adjusted and suitable sidelink DRX configuration, such that the duration (for example, the off-duration 505 of the second terminal device 120) is shortened or eliminated. In this way, the first terminal device 110 can extend the partial resource selection window 510 by adjusting the sidelink DRX configuration of the second terminal device 120, so that there may be more candidate resources that can be selected from the new partial resource selection window, thereby improving the reliability of the sidelink transmission 112.

FIG. 6 illustrates an example process 600 for selecting one or more resources for a sidelink transmission from a transmitting terminal device to a receiving terminal device in accordance with some embodiments of the present disclosure. In some embodiments, the example process 600 can be implemented at a terminal device, such as the first terminal device 110 as shown in FIG. 1A or 1B. Additionally or alternatively, the example process 600 can also be implemented at other terminal devices not shown in FIGS. 1A and 1B. For the purpose of discussion, the example process 600 will be described with reference to FIG. 1A or 1B as being performed by the first terminal device 110 without loss of generality.

At block 610, the first terminal device 110 may select, from the partial resource selection window, multiple candidate resources for the sidelink transmission 112. For example, the candidate resources can be located in Y slots within the partial resource selection window. At block 620, the first terminal device 110 may determine, among the multiple candidate resources, multiple available resources for the sidelink transmission 112 by sensing the multiple candidate resources. For example, the first terminal device 110 can perform the behavior of resource exclusion based on Physical Sidelink Control Channel (PSCCH) decoded and Sidelink Received Signal Strength Indicator (S-RSSI), Sidelink Reference Signal received Power (S-RSRP), or the like measured in the related slots. At block 630, the first terminal device 110 may select, from the multiple available resources, the one or more resources for the sidelink transmission 112. In this way, the first terminal device 110 can limit the sensing measurements on the selected candidate resources instead of all the resources in the partial resource selection window, thereby reducing the power consumption of the first terminal device 110. In one embodiment, at least one of the example processes 200 or 600 further includes performing a sidelink transmission based on the determined/selected at least one resource.

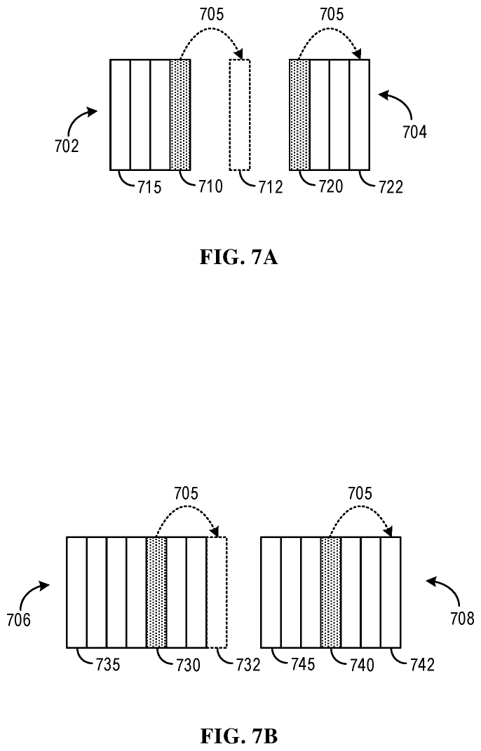

In some embodiments, if resources for a retransmission of the sidelink transmission 112 are also considered by the first terminal device 110 when selecting the one or more resources for the sidelink transmission 112, there may be more constraints on the selection of the one or more resources for transmitting the sidelink transmission 112. Such embodiments will be detailed with reference to FIGS. 7A and 7B. FIGS. 7A and 7B illustrate schematic diagrams showing that if a resource is selected for a sidelink transmission, there may be no available resource for a retransmission of the sidelink transmission in accordance with some embodiments of the present disclosure.

As shown in FIG. 7A, within the partial resource selection window (not shown in FIG. 7A), if the first terminal device 110 selects resources in a slot 710 for transmitting the sidelink transmission 112, then there may be no available resources for a potential retransmission of the sidelink transmission 112. This is because a gap 705 between the potential retransmission and the sidelink transmission 112 needs to be at least the RTT time of the retransmission, the gap 705 is assumed to be two (2) slots in the example of FIG. 7A, and the partial resource selection window does not include a slot 712 after the slot 710 by the gap 705. In contrast, if the first terminal device 110 selects resources in a slot 720 for transmitting the sidelink transmission 112, then there may be available resources for the potential retransmission of the sidelink transmission 112. This is because the partial resource selection window includes a slot 722 after the slot 720 by the gap 705.

Similarly, as shown in FIG. 7B, if the first terminal device 110 selects resources in a slot 730 for transmitting the sidelink transmission 112, then there may be no available resources for a potential retransmission of the sidelink transmission 112. This is because the partial resource selection window does not include a slot 732 after the slot 730 by the gap 705. In contrast, if the first terminal device 110 selects resources in a slot 740 for transmitting the sidelink transmission 112, then there may be available resources for the potential retransmission of the sidelink transmission 112. This is because the partial resource selection window includes a slot 742 after the slot 740 by the gap 705.

Therefore, in some embodiments, if multiple available resources determined by sensing measurements are located in multiple subsets of contiguous slots (for example, subsets 702 and 704 in FIG. 7A and subsets 706 and 708 in FIG. 7B), the first terminal device 110 can select the one or more resources for the sidelink transmission 112 in such a manner that there are available resources for a potential retransmission of the sidelink transmission 112. More particularly, in a subset of contiguous slots, the first terminal device 110 may select a resource as one of the one or more resources for the sidelink transmission 112, such that a gap between the resource and a latest slot of the subset in time domain is longer than a RTT of a retransmission of the sidelink transmission 112. In other words, the first terminal device 110 preferably selects resources from at least a gap before the end of each subset. The gap maybe (m-RTT), where m means the end slot of each subset of resource. For example, in the example scenario of FIG. 7A, the first terminal device 110 can select resources in the slot 715 in the subset 702 or the slot 720 in the subset 704. In this way, the first terminal device 110 can ensure that there are available resources for a retransmission of the sidelink transmission 112 and obtain more HARQ transmission opportunities under DRX impact, thereby improving the reliability of the sidelink transmission 112.

Alternatively or additionally, in a subset of contiguous slots, the first terminal device 110 may select an earliest resource in the subset as one of the one or more resources for transmitting the sidelink transmission 112. In other words, in a HARQ enabled resource pool, a UE preferably selects the earliest time and frequency resources from each subset of resources for initial TB transmission. For example, in the example scenario of FIG. 7B, the first terminal device 110 can select resources in the slot 735 in the subset 706 or the slot 745 in the subset 708. In this way, the first terminal device 110 can maximize the probability that there are available resources for a retransmission of the sidelink transmission and can obtain more HARQ transmission opportunities under DRX impact, thereby improving the reliability of the sidelink transmission.

In some embodiments, when determining the one or more resources for transmitting the sidelink transmission 112 within the partial resource selection window, the first terminal device 110 may determine that the sidelink DRX configuration of the second terminal device 120 is unsuitable for the sidelink transmission 112. For example, the first terminal device 110 may determine that the total number of resources within the partial resource selection window is insufficient for the sidelink transmission 112. In other words, the terminal device 110 may determine that not enough resources are within the partial resource selection window before sensing. With such a criterion for an unsuitable sidelink DRX configuration, the first terminal device 110 can increase the probability that there are sufficient resources for the sidelink transmission 112, thereby improving the reliability of the sidelink transmission 112.

As another example, the first terminal device 110 may determine that no resource within the partial resource selection window is available for a retransmission of the sidelink transmission. More particularly, the first terminal device 110 may determine that no resources can be selected for a HARQ retransmission before sensing, for example, less than the RTT within the partial resource selection window. With such a criterion for an unsuitable sidelink DRX configuration, the first terminal device 110 can increase the probability that there are sufficient resources for the sidelink transmission 112, thereby improving the reliability of the sidelink transmission 112.

As a further example, the first terminal device 110 may determine that the number of available resources within the partial resource selection window determined by performing a partial sensing within the partial resource selection window is insufficient for the sidelink transmission 112. In other words, the sensing result within the partial resource selection window is not enough. With such a criterion for an unsuitable sidelink DRX configuration, the first terminal device 110 can ensure that there are sufficient resources for the sidelink transmission 112, thereby improving the reliability of the sidelink transmission 112.

In some embodiments, if the first terminal device 110 determines that the sidelink DRX configuration of the second terminal device 120 is unsuitable for the sidelink transmission 112, the first terminal device 110 may determine an adjusted sidelink DRX configuration of the second terminal device 120. That is, if the transmitting UE of a sidelink transmission determines the DRX configuration of the receiving UE is not proper, the transmitting UE can reconfigure the DRX configuration of the receiving UE. After determining the adjusted sidelink DRX configuration of the second terminal device 120, the first terminal device 110 may transmit an indication of the adjusted sidelink DRX configuration to the second terminal device 120. Upon receiving the indication of the adjusted sidelink DRX configuration, the second terminal device 120 can apply the adjusted and suitable sidelink DRX configuration, such that the sidelink transmission 112 from the first terminal device 110 to the second terminal device 120 can be facilitated. In this way, the first terminal device 110 can change the unsuitable sidelink DRX configuration of the second terminal device 120 to a suitable sidelink DRX configuration, so that there may be more candidate resources that can be selected from the partial resource selection window, thereby improving the reliability of the sidelink transmission 112.

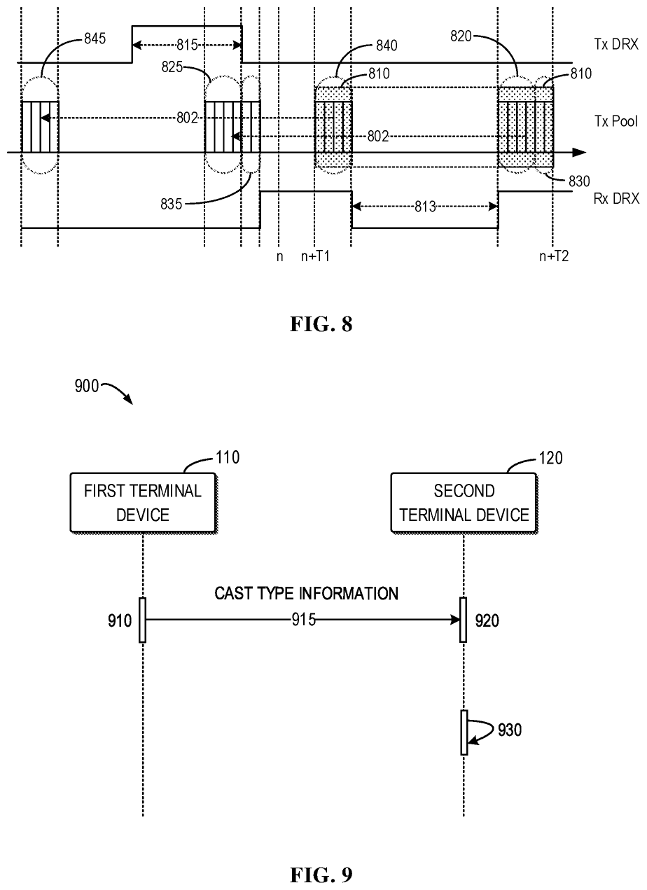

FIG. 8 illustrates a schematic diagram showing that a transmitting terminal device of a sidelink transmission can select candidate resources in slots associated with sensing occasions located in an on-duration of the transmitting terminal device in accordance with some embodiments of the present disclosure. As shown in FIG. 8, it is assumed that the transmitting terminal device is the first terminal device 110, the sidelink transmission is the sidelink transmission 112, and the receiving terminal device is the second terminal device 120 in the example scenario of FIG. 1A or 1B. It is also assumed that the first terminal device 110 determines to transmit the sidelink transmission 112 in slot n, and a resource selection window is determined as [n+T1, n+T2]. The first terminal device 110 further determines a partial resource selection window 810 without an off-duration 813 of the second terminal device 120.

It can be seen that a set of slots 820, a set of slots 830, and a set of slots 840 are associated with sensing occasions 825, sensing occasions 835, and sensing occasions 845, respectively. The gap between any one of the sets of slots and the associated sensing occasions are shown as gap 802, which for example can be determined according to some parameters (such as, the parameters k and p) defined in related 3GPP specifications, such as, TS 36.213. It can be noted that the sensing occasions 825 (also termed as available sensing occasions) associated with the set of slots 820 are located in an on-duration 815 of the first terminal device 110, whereas the sensing occasions 835 and sensing occasions 845 associated with the set of slots 830 and the set of slots 840, respectively, are located in an off-duration of the first terminal device 110. This means that the first terminal device 110 may be unable determine whether resources in the set of slots 830 and the set of slots 840 are reserved by other terminal devices, since the first terminal device 110 may be unable to receive sidelink information or signals during an off-duration.

Therefore, in some embodiments, when determining one or more resources for the sidelink transmission 112 within the partial resource selection window 810, the first terminal device 110 may first determine the set of slots 820 within the partial resource selection window 810. As mentioned, the set of slots 820 are associated with respective sensing occasions 825 located in the on-duration 815 of the sidelink DRX configuration of the first terminal device 110. Then, the first terminal device 110 may determine the one or more resources from the set of slots 820, which one or more resources are to be used for the sidelink transmission 112. In this way, the first terminal device 110 can ensure that the available candidate resources determined after sensing measurements are not reserved by other terminal devices, thereby improving the reliability of the sidelink transmission 112, enhancing the resource selection, and reducing resource conflicts under DRX impact.

Although the first terminal device 110 can ensure the one or more resources from the set of slots 820 are available after sensing measurements, the set of slots 820 may include fewer slots than the partial resource selection window 810. In other words, if the one or more resources are limited to be selected from the set of slots 820, there may be insufficient resources in some situations. Therefore, in some embodiments, the first terminal device 110 can limit the one or more resources to be in the set of slots 820 only for a sidelink transmission associated with an important traffic. More particularly, if a traffic priority associated with the sidelink transmission 112 is higher than a priority threshold (for example, a traffic priority value is smaller than a configured threshold), the first terminal device 110 may determine the set of slots 820 for performing sensing measurements. In some embodiments, the configured threshold can be predefined or can be informed to the first terminal device 110 via an RRC message. In some embodiments, the configured threshold can have a value ranging from 1 to 8. In this way, the reliability of a sidelink transmission associated with a more important traffic can be ensured, whereas for a sidelink transmission associated with a less important traffic, the resource selection procedure can be simplified and there can be more candidate resources.

In some embodiments, the set of slots 820 can be determined by a lower layer (for example, a physical layer) of the first terminal device 110. More specifically, the first terminal device 110 may cause the lower layer to determine the set of slots 820. In these embodiments, when determining the one or more resources from the set of slots 820 for the sidelink transmission 112, the first terminal device 110 may cause the lower layer to report available resources in the set of slots 820 to a higher layer (for example, a MAC layer) of the first terminal device 110. For example, the available resources are determined through sensing measurements on candidate resources selected from the set of slots 820. Then, the first terminal device 110 may cause the higher layer to select the one or more resources from the available resources. In other words, in the physical layer and within the partial resource selection window, a UE can only or preferably determine the slot set Y as the slot set S whose associated sensing occasions are located in an on-duration of the UE and reports the candidate resources to the MAC layer. In this way, the operation of the higher layer (for example, the MAC layer) can be simplified.

In some other embodiments, the set of slots 820 can be determined by the higher layer (for example, the MAC layer) of the first terminal device 110. More specifically, the first terminal device 110 may cause the higher layer to determine the set of slots 820. In these embodiments, when determining the one or more resources from the set of slots 820 for the sidelink transmission 112, the first terminal device 110 may cause the lower layer to report candidate resources within the partial resource selection window. Then, the first terminal device 110 may cause the higher layer to select the one or more resources from the candidate resources, such that the one or more resources are located in the set of slots 820. In other words, in the MAC layer and within the reported set of resources S_{A} from the physical layer, a UE can only or preferably select resources within the slot set S whose associated sensing occasions are located in an on-duration of the UE. In this way, the operation of the lower layer (for example, the physical layer) can be simplified.

FIG. 9 illustrates an example communication process 900 between the first terminal device 110 and the second terminal device 120 in accordance with some embodiments of the present disclosure. For the purpose of discussion, the communication process 900 will be described with reference to FIGS. 1A and 1B. However, it would be appreciated that the communication process 900 may be equally applicable to any other communication scenarios where two terminal devices communicate with each other.

As shown in FIG. 9, before the first terminal device 110 transmits the sidelink transmission 112 to the second terminal device 120, the first terminal device 110 transmits (910) cast type information 915 to the second terminal device 120. For example, the cast type information 915 may indicate that the sidelink transmission 112 is a unicast sidelink transmission from the first terminal device 110 to the second terminal device 120, such as in the example scenario shown in FIG. 1A. As another example, the cast type information 915 may indicate that the sidelink transmission 112 is a groupcast or broadcast sidelink transmission from the first terminal device 110 to multiple terminal devices (for example, the second, third, and fourth terminal devices 120, 130 and 140 in FIG. 1B) including the second terminal device 120, such as in the example scenario shown in FIG. 1B. In some embodiments, the cast type information 915 can be transmitted via scheduling information (for example, Sidelink Control Information, SCI) of the sidelink transmission 112. In some other embodiments, the cast type information 915 can also be transmitted via signaling other than the scheduling information of the sidelink transmission 112.

On the receiving side, the second terminal device 120 receives (920) the cast type information 915 from the first terminal device 110. Based on the cast type information 915, the second terminal device 120 may determine (930) an enablement configuration of a sidelink DRX of the second terminal device 120 during the sidelink transmission. More particularly, the second terminal device 120 can enable or disable the DRX mechanism for the partial sensing procedure performed by the first terminal device 110 for the sidelink transmission 112, so as to facilitate the partial sensing procedure on the transmitting side of the sidelink transmission 112. For example, the second terminal device 120 may enable or disable the DRX mechanism depending on the cast type (such as unicast, groupcast, or broadcast) of the sidelink transmission 112. In this way, better transmission or reception efficiency of the sidelink transmission 112 from the first terminal device 110 to the second terminal device 120 under DRX impact can be achieved.

In some embodiments, if the cast type information 915 indicates that the sidelink transmission 112 is a unicast sidelink transmission, for example, the indicated cast type in the SCI of the sidelink transmission 112 is “unicast,” then the second terminal device 120 may enable the sidelink DRX during the sidelink transmission 112. For example, this may be the case in which a DRX configuration is pre-configured or configured per UE, namely, pre-configured or configured individually for the second terminal device 120. In this way, the partial sensing procedure of the first terminal device 110 can be applied together with the DRX mechanism of the second terminal device 120. As such, power consumption of both the first terminal device 110 and the second terminal device 120 can be effectively reduced.

In some other embodiments, if the cast type information 915 indicates that the sidelink transmission 112 is a groupcast or broadcast sidelink transmission, for example, the indicated cast type in the SCI of the sidelink transmission 112 is not “unicast” (such as a groupcast option 1, a groupcast option 2, and a broadcast), then the second terminal device may disable the sidelink DRX during the sidelink transmission 112. For example, this may be the case in which a DRX configuration is pre-configured or configured per UE, namely, pre-configured or configured individually for the second terminal device 120. In this way, the first terminal device 110 does not need to exclude, from the partial resource selection window, a common off-duration or a combined off-duration of the target terminal devices of the groupcast or broadcast sidelink transmission, so that there may be more candidate resources that can be selected from the partial resource selection window.

In some further embodiments, a sidelink DRX configuration of the second terminal device 120 may be pre-configured or configured for a resource pool in which a resource is selected for the sidelink transmission 112, rather than individually pre-configured or configured for the second terminal device 120. In other words, the sidelink DRX configuration is pre-configured or configured per resource pool. In this event, the second terminal device 120 may enable the sidelink DRX during the sidelink transmission 112 regardless of the cast type information 915. In this way, the first terminal device 110 merely needs to exclude, from the partial resource selection window, the same off-duration of the target terminal devices of the groupcast or broadcast sidelink transmission, so that there may be more candidate resources that can be selected from the partial resource selection window. As such, the partial sensing procedure of the first terminal device 110 can be applied together with the DRX mechanism of target terminal devices. Thus, power consumption of both the first terminal device 110 and the target terminal devices can be effectively reduced.

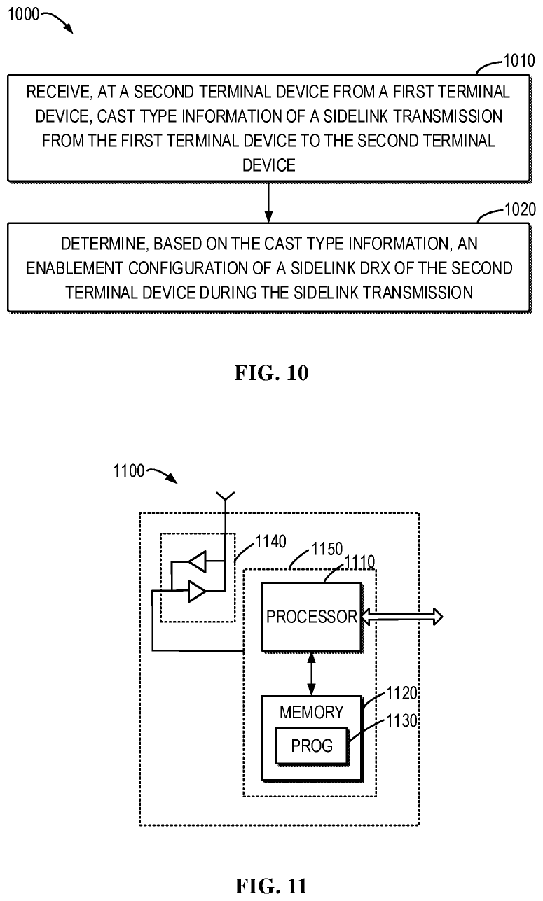

FIG. 10 illustrates an example process 1000 of another method for communication in accordance with some embodiments of the present disclosure. In some embodiments, the example process 1000 can be implemented at a terminal device, such as the second terminal device 120 as shown in FIG. 1A or 1B. Additionally or alternatively, the example process 1000 can also be implemented at other terminal devices not shown in FIGS. 1A and 1B. For the purpose of discussion, the example process 1000 will be described with reference to FIG. 1A or 1B as being performed by the second terminal device 120 without loss of generality.

At block 1010, the second terminal device 120 receives, from the first terminal device 110, cast type information of a sidelink transmission from the first terminal device 110 to the second terminal device 120. At block 1020, the second terminal device 120 determines, based on the cast type information, an enablement configuration of a sidelink DRX of the second terminal device 120 during the sidelink transmission.

In some embodiments, when determining the enablement configuration, if the cast type information indicates that the sidelink transmission is a unicast sidelink transmission, the second terminal device 120 can enable the sidelink DRX during the sidelink transmission.

In some embodiments, when determining the enablement configuration, if the cast type information indicates that the sidelink transmission is a groupcast or broadcast sidelink transmission, the second terminal device 120 can disable the sidelink DRX during the sidelink transmission.

In some embodiments, if a sidelink DRX configuration of the second terminal device 120 is pre-configured or configured for a resource pool in which a resource is selected for the sidelink transmission, the second terminal device 120 may enable the sidelink DRX during the sidelink transmission regardless of the cast type information.

According to embodiments of the present disclosure, a first terminal device comprises circuitry configured to: determine a resource selection window for a sidelink transmission from the first terminal device to a second terminal device; determine a duration within the resource selection window; and determine, within the resource selection window without the duration, at least one resource for the sidelink transmission.

In some embodiments, the circuitry is configured to determine the duration by determining the duration based on a sidelink discontinuous reception (DRX) configuration of the second terminal device.

In some embodiments, the circuitry is configured to determine the duration based on the sidelink DRX configuration by: in accordance with a determination that the sidelink transmission is a unicast sidelink transmission to the second terminal device, determining an off-duration of the DRX configuration of the second terminal device as the duration.

In some embodiments, the circuitry is configured to determine the duration based on the sidelink DRX configuration by: in accordance with a determination that the sidelink transmission is a groupcast or broadcast sidelink transmission to a plurality of terminal devices including the second terminal device, determining a plurality of off-durations of respective sidelink DRX configurations of the plurality of terminal devices; and determining a common off-duration or a combined off-duration of the plurality of off-durations as the duration.

In some embodiments, the circuitry is further configured to: in accordance with a determination that a previous sidelink transmission from the first terminal device is performed in a sensing occasion associated with a slot within a remaining part of resource selection window without the duration, exclude the slot from the remaining part of the resource selection window.

In some embodiments, the circuitry is further configured to: in accordance with a determination that the number of slots within a remaining part of the resource selection window without the duration is less than a threshold, extend the remaining part of the resource selection window.

In some embodiments, the threshold is one of the following: a value pre-configured or configured by a higher layer of the first terminal device, a minimum number of slots within the resource selection window pre-configured or configured by the higher layer, and a sum of the minimum number and the number of slots for a round trip time of a retransmission of the sidelink transmission.

In some embodiments, the circuitry is configured to extend the remaining part of the resource selection window by at least one of the following: advancing a start time point of the remaining part of the resource selection window; and delaying an end time point of the remaining part of the resource selection window.

In some embodiments, the circuitry is configured to extend the remaining part of the resource selection window by: determining an adjusted sidelink DRX configuration of the second terminal device such that the duration is shortened or eliminated; and transmitting an indication of the adjusted sidelink DRX configuration to the second terminal device.

In some embodiments, the circuitry is configured to determine the at least one resource by: selecting, from a remaining part of the resource selection window without the duration, a plurality of candidate resources for the sidelink transmission; determining, among the plurality of candidate resources, a plurality of available resources for the sidelink transmission by sensing the plurality of candidate resources; and selecting the at least one resource from the plurality of available resources.

In some embodiments, the plurality of available resources are located in a plurality of subsets of contiguous slots, and the circuitry is configured to select the at least one resource by at least one of the following: selecting, from a subset of the plurality of subsets, a resource as one of the at least one resource, a gap between the resource and a latest slot of the subset in time domain being longer than a round trip time of a retransmission of the sidelink transmission; and selecting, from a subset of the plurality of subsets, an earliest resource in the subset as one of the at least one resource.

In some embodiments, the circuitry is further configured to: in accordance with a determination that the sidelink DRX configuration of the second terminal device is unsuitable for the sidelink transmission, determine an adjusted sidelink DRX configuration of the second terminal device; and transmit an indication of the adjusted sidelink DRX configuration to the second terminal device.

In some embodiments, the determination that the sidelink DRX configuration of the second terminal device is unsuitable comprises at least one of the following: determining that the total number of resources within a remaining part of the resource selection window without the duration is insufficient for the sidelink transmission; determining that no resource within the remaining part of the resource selection window is available for a retransmission of the sidelink transmission; and determining that the number of available resources within the remaining part of the resource selection window determined by performing a partial sensing within the remaining part of the resource selection window is insufficient for the sidelink transmission.

In some embodiments, the circuitry is configured to determine the at least one resource by: determining, within a remaining part of the resource selection window without the duration, a set of slots associated with respective sensing occasions located in an on-duration of a sidelink DRX configuration of the first terminal device; and determining the at least one resource from the set of slots.

In some embodiments, the circuitry is configured to determine the set of slots by: causing a lower layer of the first terminal device to determine the set of slots.

In some embodiments, the circuitry is configured to determine the at least one resource from the set of slots by: causing the lower layer to report available resources in the set of slots to a higher layer of the first terminal device; and causing the higher layer to select the at least one resource from the candidate resources.

In some embodiments, the circuitry is configured to determine the set of slots by: causing a higher layer of the first terminal device to determine the set of slots.

In some embodiments, the circuitry is configured to determine the at least one resource from the set of slots by: causing a lower layer of the first terminal device to report candidate resources within the remaining part of the resource selection window; and causing the higher layer to select, from the candidate resources, the at least one resource located in the set of slots.

In some embodiments, the circuitry is configured to determine the set of slots by: in accordance with a determination that a traffic priority associated with the sidelink transmission is higher than a priority threshold, determining the set of slots.

According to embodiments of the present disclosure, a second terminal device comprises circuitry configured to: receive, from a first terminal device, cast type information of a sidelink transmission from the first terminal device to the second terminal device; and determine, based on the cast type information, an enablement configuration of a sidelink discontinuous reception (DRX) of the second terminal device during the sidelink transmission.

In some embodiments, the circuitry is configured to determine the enablement configuration by: in accordance with a determination that the cast type information indicates that the sidelink transmission is a unicast sidelink transmission, enabling the sidelink DRX during the sidelink transmission.

In some embodiments, the circuitry is configured to determine the enablement configuration by: in accordance with a determination that the cast type information indicates that the sidelink transmission is a groupcast or broadcast sidelink transmission, disabling the sidelink DRX during the sidelink transmission.

In some embodiments, the circuitry is further configured to: in accordance with a determination that a sidelink DRX configuration of the second terminal device is pre-configured or configured for a resource pool in which a resource is selected for the sidelink transmission, enable the sidelink DRX during the sidelink transmission regardless of the cast type information.

FIG. 11 is a simplified block diagram of a device 1100 that is suitable for implementing some embodiments of the present disclosure. The device 1100 can be considered as a further embodiment of the network device 105, the first terminal device 110, the second terminal device 120, the third terminal device 130, and the fourth terminal device 140 as shown in FIGS. 1A and 1B. Accordingly, the device 1100 can be implemented at or as at least a part of the network device 105, the first terminal device 110, the second terminal device 120, the third terminal device 130, and the fourth terminal device 140.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 or Xn interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1130 is assumed to include program instructions that, when executed by the associated processor 1110, enable the device 1100 to operate in accordance with the embodiments of the present disclosure, as discussed herein with reference to any of the aforementioned figures. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In some embodiments, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of the figures. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communication, comprising:
determining, at a first terminal device, a resource selection window for a sidelink transmission from the first terminal device to a second terminal device;
determining a duration within the resource selection window; and
determining, within the resource selection window without the duration, at least one resource for the sidelink transmission.

2. The method of claim 1, wherein determining the duration comprises:
determining the duration based on a sidelink discontinuous reception (DRX) configuration of the second terminal device.

3. The method of claim 2, wherein determining the duration based on the sidelink DRX configuration comprises:
in accordance with a determination that the sidelink transmission is a unicast sidelink transmission to the second terminal device, determining an off-duration of the DRX configuration of the second terminal device as the duration.

4. The method of claim 2, wherein determining the duration based on the sidelink DRX configuration comprises:
in accordance with a determination that the sidelink transmission is a groupcast or broadcast sidelink transmission to a plurality of terminal devices including the second terminal device, determining a plurality of off-durations of respective sidelink DRX configurations of the plurality of terminal devices; and
determining a common off-duration or a combined off-duration of the plurality of off-durations as the duration.

5. The method of claim 1, further comprising:
in accordance with a determination that a previous sidelink transmission from the first terminal device is performed in a sensing occasion associated with a slot within a remaining part of resource selection window without the duration, excluding the slot from the remaining part of the resource selection window.

6. The method of claim 1, further comprising:
in accordance with a determination that the number of slots within a remaining part of the resource selection window without the duration is less than a threshold, extending the remaining part of the resource selection window.

7. The method of claim 6, wherein the threshold is one of the following:
a value pre-configured or configured by a higher layer of the first terminal device,
a minimum number of slots within the resource selection window pre-configured or configured by the higher layer, and
a sum of the minimum number and the number of slots for a round trip time of a retransmission of the sidelink transmission.

8. The method of claim 6, wherein extending the remaining part of the resource selection window comprises at least one of the following:
advancing a start time point of the remaining part of the resource selection window; and
delaying an end time point of the remaining part of the resource selection window.

9. The method of claim 6, wherein extending the remaining part of the resource selection window comprises:
determining an adjusted sidelink DRX configuration of the second terminal device such that the duration is shortened or eliminated; and
transmitting an indication of the adjusted sidelink DRX configuration to the second terminal device.

10. The method of claim 1, wherein determining the at least one resource comprises:
selecting, from a remaining part of the resource selection window without the duration, a plurality of candidate resources for the sidelink transmission;
determining, among the plurality of candidate resources, a plurality of available resources for the sidelink transmission by sensing the plurality of candidate resources; and
selecting the at least one resource from the plurality of available resources.

11. The method of claim 10, wherein the plurality of available resources are located in a plurality of subsets of contiguous slots, and selecting the at least one resource comprises at least one of the following:
selecting, from a subset of the plurality of subsets, a resource as one of the at least one resource, a gap between the resource and a latest slot of the subset in time domain being longer than a round trip time of a retransmission of the sidelink transmission; and
selecting, from a subset of the plurality of subsets, an earliest resource in the subset as one of the at least one resource.

12. The method of claim 2, further comprising:
in accordance with a determination that the sidelink DRX configuration of the second terminal device is unsuitable for the sidelink transmission, determining an adjusted sidelink DRX configuration of the second terminal device; and
transmitting an indication of the adjusted sidelink DRX configuration to the second terminal device.

13. The method of claim 12, wherein the determination that the sidelink DRX configuration of the second terminal device is unsuitable comprises at least one of the following:
determining that the total number of resources within a remaining part of the resource selection window without the duration is insufficient for the sidelink transmission;
determining that no resource within the remaining part of the resource selection window is available for a retransmission of the sidelink transmission; and
determining that the number of available resources within the remaining part of the resource selection window determined by performing a partial sensing within the remaining part of the resource selection window is insufficient for the sidelink transmission.

14. The method of claim 1, wherein determining the at least one resource comprises:
determining, within a remaining part of the resource selection window without the duration, a set of slots associated with respective sensing occasions located in an on-duration of a sidelink DRX configuration of the first terminal device; and
determining the at least one resource from the set of slots.

15. The method of claim 14, wherein determining the set of slots comprises:
causing a lower layer of the first terminal device to determine the set of slots.

16. The method of claim 15, wherein determining the at least one resource from the set of slots comprises:
causing the lower layer to report available resources in the set of slots to a higher layer of the first terminal device; and
causing the higher layer to select the at least one resource from the available resources.

17. The method of claim 14, wherein determining the set of slots comprises:
causing a higher layer of the first terminal device to determine the set of slots.

18. The method of claim 17, wherein determining the at least one resource from the set of slots comprises:
causing a lower layer of the first terminal device to report candidate resources within the remaining part of the resource selection window; and
causing the higher layer to select, from the candidate resources, the at least one resource located in the set of slots.

19. The method of claim 14, wherein determining the set of slots comprises:
in accordance with a determination that a traffic priority associated with the sidelink transmission is higher than a priority threshold, determining the set of slots.

20. A method for communication, comprising:
receiving, at a second terminal device from a first terminal device, cast type information of a sidelink transmission from the first terminal device to the second terminal device; and
determining, based on the cast type information, an enablement configuration of a sidelink discontinuous reception (DRX) of the second terminal device during the sidelink transmission.

21. The method of claim 20, wherein determining the enablement configuration comprises:
in accordance with a determination that the cast type information indicates that the sidelink transmission is a unicast sidelink transmission, enabling the sidelink DRX during the sidelink transmission.

22. The method of claim 20, wherein determining the enablement configuration comprises:
in accordance with a determination that the cast type information indicates that the sidelink transmission is a groupcast or broadcast sidelink transmission, disabling the sidelink DRX during the sidelink transmission.

23. The method of claim 20, further comprising:
in accordance with a determination that a sidelink DRX configuration of the second terminal device is pre-configured or configured for a resource pool in which a resource is selected for the sidelink transmission, enabling the sidelink DRX during the sidelink transmission regardless of the cast type information.

24. A first terminal device comprising:
a processor configured to perform the method of any of claims 1-19.

25. A second terminal device comprising:
a processor configured to perform the method of any of claims 20-23.

26. A computer readable medium having instructions stored thereon, the instructions, when executed on at least one processor of a device, causing the device to perform the method of any of claims 1-19.

27. A computer readable medium having instructions stored thereon, the instructions, when executed on at least one processor of a device, causing the device to perform the method of any of claims 20-23.
